(19) United States
(12) Patent Application Publication
(10) Pub. No.: US 2015/0319328 A1
(43) Pub. Date: Nov. 5, 2015

(54) METHODS, SYSTEMS AND PROCESSOR-READABLE MEDIA FOR PREVENTING RENDERING JOBS/SETS FROM BEING SPLIT BEFORE STACKER IS FULL

(71) Applicant: Xerox Corporation, Norwalk, CT (US)

(72) Inventors: Paul F. Brown, Webster, NY (US); Gregg A. Bonikowski, Rochester, NY (US); Andrew S. McVey, Redondo Beach, CA (US); Timothy J. Kelley, Pittsford, NY (US)

(73) Assignee: Xerox Corporation, Norwalk, CT (US)

(21) Appl. No.: 14/268,077

(22) Filed: May 2, 2014

(51) Int. Cl. H04N 1/00; H04N 1/32; H04L 29/08

(52) U.S. Cl. CPC H04N 1/00954; H04L 67/10; H04N 1/00957; H04N 1/00482; H04N 1/32496; H04N 1/00925; H04N 2201/0094

(57) ABSTRACT

Methods, systems and processor-readbale media for preventing a job/set splitting across a stacker. A splitting prevention module can be configured to include a prevent job splitting feature or a prevent set splitting feature. The prevent job splitting feature and the prevent set splitting feature can be selected by a user so that the stacker will not begin stacking the job/set unless the stacker possesses a capacity for stacking the complete job/set. The stacker automatically unloads the job/set with respect to a job/set boundary provided by the user. Such an approach prevents the jobs/sets from being split when the stacker goes full.

### FIELD OF THE INVENTION

Embodiments are generally related to multi-function devices such as, printers, scanners, photocopy machines, and the like. Embodiments are also related to multi-function device stackers. Embodiments are additionally related to techniques for preventing rendering jobs/sets splitting across stackers.

### BACKGROUND

A MFD (Multi-Function Device) is a rendering device or office machine, which incorporates the functionality of multiple devices in a single apparatus or system, so as to leave a smaller footprint in a home or small business setting, or to provide centralized document management/distribution/production in the context of, for example, a large-office setting. A typical MFD may provide a combination of some or all of the following capabilities: printer, scanner, photocopier, fax machine, e-mail capability, etc. Networked MFDs (Multi-Function Devices) generally interact with an assemblage of varying rendering devices, client computers, servers, and other components that are connected to and communicate over a network.

The use of MFD stackers has created a new standard for productivity and cost effectiveness because it delivers all of the features of a digital production stacker within a smaller footprint. MFD stackers are designed to collate and stack print jobs/sets. The stackers receive print jobs/sets output from the MFD and route them to other document production units. Conventionally, MFD stackers can be unloaded when they go “full” independent of whether they are in the middle of a job/set, which can lead to split jobs/sets. If there is more than one stacker, the job/set can resume printing in another stacker. The job/set can be manually recompiled when the next stack is uploaded. Such a process is messy and error prone.

Based on the foregoing, it is believed that a need exists for improved methods and systems for preventing jobs/sets splitting across stackers, as will be described in greater detail herein.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved methods and systems for managing a MFD or other rendering device.

It is another aspect of the disclosed embodiments to provide for improved methods and systems for preventing a job/set splitting across stackers.

The aforementioned aspects and other objectives and advantages can now be achieved as described herein. Methods and systems are disclosed for preventing job/set splitting across a stacker. The disclosed approach generally involves the creation of a feature that prevents jobs/sets from being split when the stackers go “full”. When the feature is selected by a user, the stacker will not begin stacking a job/set unless the stacker has sufficient room for the complete job/set, resulting in the stacker automatically unloading at job/set boundaries.

In one embodiment, a splitting prevention module can be configured to include a prevent job splitting feature and a prevent set splitting feature. The prevent job splitting feature and the prevent set splitting feature can be selected by a user so that the stacker will not begin stacking the job/set unless the stacker posses a capacity for stacking the complete job/set. The stacker automatically unloads the job/set with respect to a job/set boundary provided by the user. Such an approach prevents the jobs/sets from being split when the stacker goes full.

The prevent job splitting feature can be selected and a maximum job thickness value, in units of millimeters or inches, can be entered. The maximum job thickness value can be employed to unload a last whole job that can fit in the stacker before going full if the remaining stacker capacity is less than or equal to the maximum job thickness value. The prevent set splitting feature can be selected and a maximum set thickness value, in units of millimeters or inches, can be entered. The maximum set thickness value can be employed to unload the last whole set that can fit in the stacker before going full if the remaining stacker capacity is less than or equal to the maximum set thickness value.

The disclosed approach can ensure that the jobs/sets are not split which prevent manual recompilation. The feature can be extended to other product lines that can physically detect the remaining stacker capacity. The specification of maximum set/job size in dimensional units can be provided by the user to avoid splitting of sets/jobs across stackers. Such an approach reduces the opportunity for user error when recombining the jobs/sets that have been split at non-set boundaries.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an example of a multi-function device coupled to a data-processing apparatus through a network, in accordance with the disclosed embodiments;

FIG. 2 illustrates a graphical representation of a device management system having a job/set splitting prevention module associated with a network, in accordance with the disclosed embodiments;

FIG. 3 illustrates a block diagram of a job/set splitting prevention system having a prevent job splitting feature and a prevent set splitting feature, in accordance with the disclosed embodiments; and

FIG. 4 illustrates a high level flow chart of operations illustrating logical operational steps of a method for preventing a job/set splitting across the stacker, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

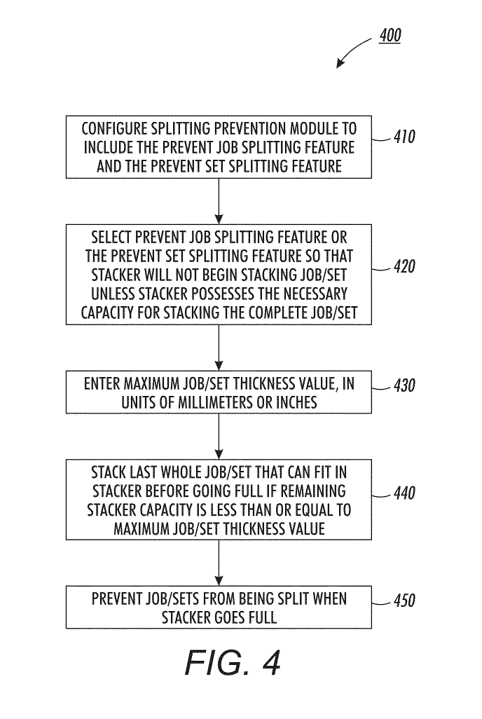

The disclosed embodiments are described in part below with reference to flowchart illustrations and/or block diagrams of methods, systems, computer program products and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks. Examples of such computer instructions are shown, for example, via the method shown in FIG. 4.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

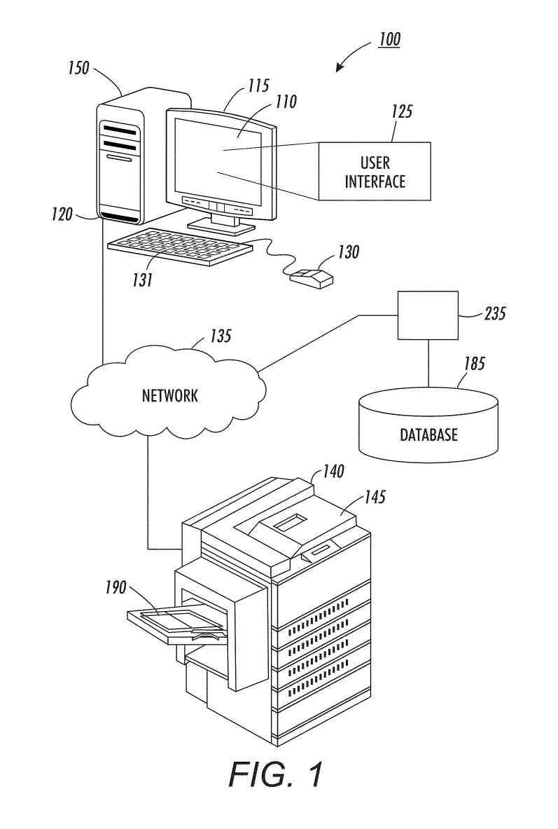

Referring to FIG. 1, a system 100 can be configured to include one or more networked devices, such as a networked device 140, which can communicate electronically with a data-processing apparatus 110 through a network 135. A server 235 can also communicate with the network 135 and hence, device 140, etc. The server 235 can also support or communicate with a database 185. In some embodiments, networked device 140 may be a rendering device such as a printer, scanner, copy machine, etc. In other embodiments, networked device 140 may be a MFD, a file server, a print server, etc. The data-processing apparatus 110 may be, for example, a computer or other computing device (e.g., tablet computer, smartphone, laptop computer, server, etc.), and generally includes a central processor 120, a display device 115, and in some cases a keyboard 131 and/or a pointing device 130 (e.g., mouse, touch pad, touch screen input, etc.).

Note that as utilized herein, the term “networked device” may refer to an apparatus or system such as a printer, scanner, fax machine, copy machine, etc., and/or a combination thereof (e.g., a MFD). Preferably, networked device 140 is a MFD capable of multiple rendering functions such as printing, copying, scanning, faxing, etc. In some embodiments, the MFD 140 may be implemented with a single rendering function such as printing or photocopying. In other embodiments, the MFD 140 can be configured to provide multiple rendering functions, such as scanning, faxing, printing and copying.

The data-processing apparatus 110 can communicate electronically with the MFD 140 (i.e., and/or other rendering devices) through a computer network 135. Network 135 may employ any network topology, transmission medium, or network protocol. The network 135 may include connections such as wire, wireless communication links, or fiber optic cables. In the depicted example, network 135 is the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational, and other computer systems that route data and messages. Thus, in some embodiments network 135 may be a wireless communications network (e.g., WiFi).

The networked MFD 140 may include a user interface 145, which includes a panel menu. MFD 140 may also include a stacker 190 having an automatic level elevator tray or removable container for convenient collection and subsequent removal of rendering job/set. The panel menu may be used to select features and enter other data to the MFD 140. Such interfaces may include, for example, touch screens having touch activated keys for navigating through an option menu or the like. A driver program, for example, can be installed on the data-processing apparatus 110 and can reside on the host device's hard drive 150. The driver program may be activated through an application interface so that a user may generate a rendering job with the driver for processing by the MFD 140.

The data-processing apparatus 110 may also include a GUI 125 for communicating rendering features for processing, for example, the rendering job to a user and accepting the user's selection of available rendering features. The user interface 125 displays information and receives data through device display and/or the keyboard/mouse combination. The interface 125 also serves to display results, whereupon the user may supply additional inputs or terminate a given session. The data-processing apparatus 110 can be, for example, any computing device capable of being integrated within a network, such as a PDA, personal computer, cellular telephone, point-of-sale terminal, server, etc.

The input device of the networked device 140, for example, may be a local user interface 145, such as a touch-screen display or separate keypad and display or a memory fob or the like as discussed above. Alternatively or additionally, the input device may be a wireless port that receives a wireless signal containing constraint data from a portable device. The wireless signal may be an infrared or electromagnetic signal. A system administrator may input constraint data through the local user interface by manipulating the touch screen, keypad, or communicating via wireless messages through the wireless port. The administrator's portable device that communicates wirelessly may be a personal digital assistant (PDA), or the like, as noted above.

The following description is presented with respect to embodiments of the disclosed embodiments, which can be embodied in the context of the data-processing apparatus 110 and the networked device 140 depicted in FIG. 1. The disclosed embodiments, however, are not limited to any particular application or any particular environment. Instead, those skilled in the art will find that the system and method of the disclosed embodiments may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

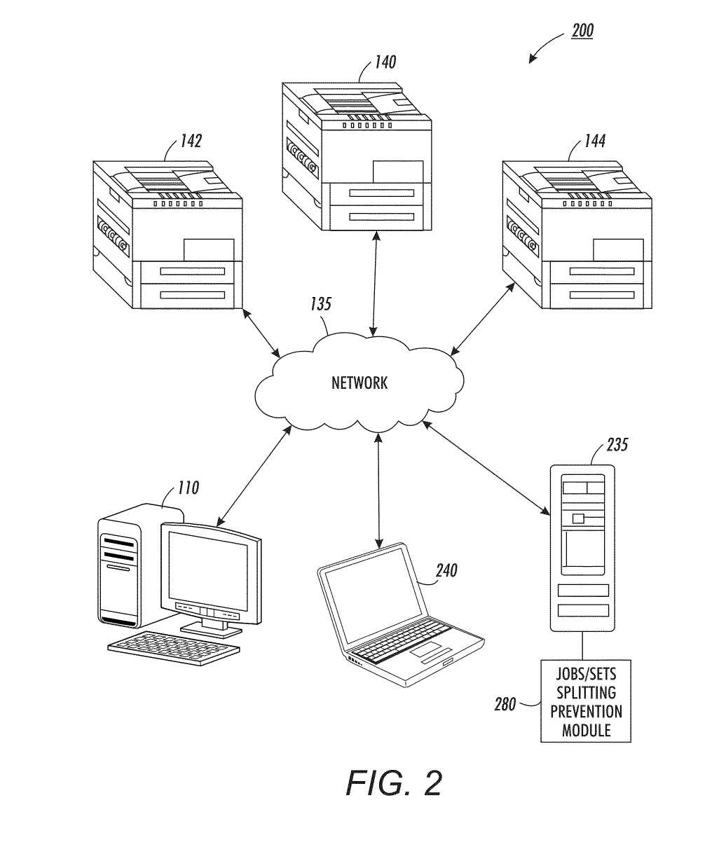

FIG. 2 illustrates a graphical representation of a device management system 200 having a print job/set splitting prevention module 280 associated with the network 135, in accordance with the disclosed embodiments. The device management system 200 generally includes the network infrastructure 135 associated with one or more networked MFDs 140, 142, and 144, data-processing system 110, a laptop 240, and a server 235. Note that in some embodiments, server 235 may be provided as an EIP (Extensible Interface Platform) server. An EIP is a software platform that allows independent software developers to create personalized document management solutions capable of being accessed from, for example, a touch screen interface associated with a MFD such as MFDs 140, 142, 144, etc., or other devices.

Data-processing apparatus 110 depicted in FIG. 1 can be, for example, a server. Other devices such as, for example, desktops, network devices, palmtops, mobile phones, etc., may also be included in the network 135, as service providers. The MFDs 140, 142, and 144 can be located remotely with respect to each other, or alternatively, they may be located locally with respect to each other.

The typical MFD 140 may act as a combination of a printer, scanner, photocopier, fax, and e-mail. While three MFDs 140, 142, and 144 are shown by way of example, it is to be appreciated that any number of MFDs 140, 142, and 144 may be linked to the network 135, such as, four, six or more rendering devices. In general, the MFDs 140, 142, and 144 can be employed to perform a rendering output function (e.g., printing, scanning, copying, faxing, etc.) within a networked environment. Note that MFDs 140, 142, and 144 are generally analogous to one another.

The print job/set splitting prevention module 280 is configured in association with the server 235 for preventing a job/set splitting across the stacker 190. Note that as utilized herein, the term “module” may refer to a physical hardware component and/or to a software module. In the computer programming arts, such a software “module” may be implemented as a collection of routines and data structures that performs particular tasks or implements a particular abstract data type. Modules of this type are generally composed of two parts. First, a software module may list the constants, data types, variable, routines, and so forth that can be accessed by other modules or routines. Second, a software module may be configured as an implementation, which can be private (i.e., accessible only to the module), and which contains the source code that actually implements the routines or subroutines upon which the module is based.

Therefore, when referring to a “module” herein, the inventors are generally referring to such software modules or implementations thereof. The methodology described herein can be implemented as a series of such modules or as a single software module. Such modules can be utilized separately or together to form a program product that can be implemented through signal-bearing media, including transmission media and recordable media. The present invention is capable of being distributed as a program product in a variety of forms, which apply equally regardless of the particular type of signal-bearing media utilized to carry out the distribution.

Examples of signal-bearing media can include, for example, recordable-type media, such as floppy disks, hard disk drives, CD ROMs, CD-Rs, etc., and transmission media, such as digital and/or analog communication links. Examples of transmission media can also include devices such as modems, which permit information to be transmitted over standard telephone lines and/or the more advanced digital communications lines.

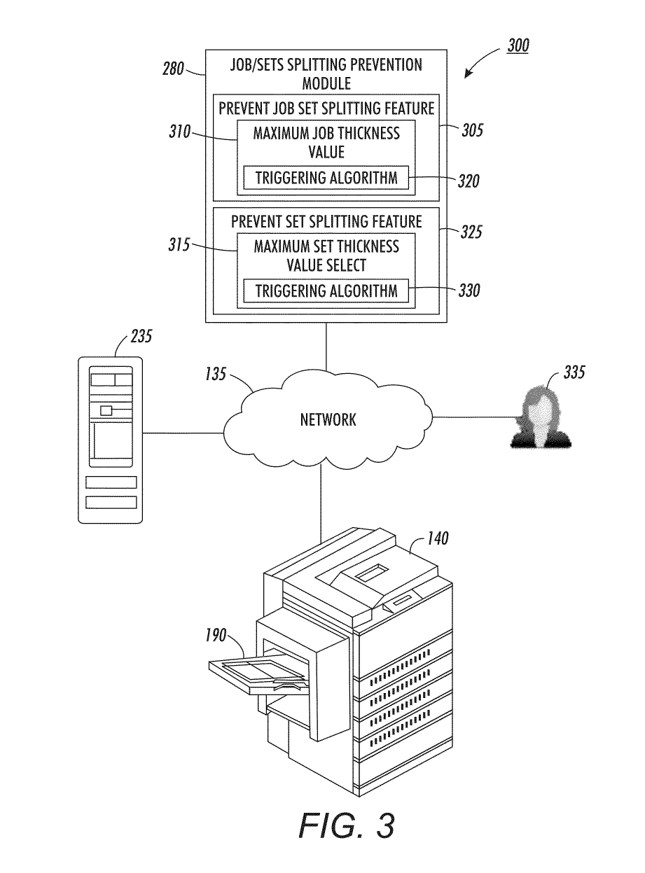

FIG. 3 illustrates a block diagram of a job/set splitting prevention system 300 having a prevent job splitting feature 305 and a prevent set splitting feature 325, in accordance with a preferred embodiment. Note that in FIGS. 1-4, identical or similar blocks are generally indicated by identical reference numerals, even if referring to different embodiments. A splitting prevention module 280 can be configured to include the prevent job splitting feature 305 or the prevent set splitting feature 325 to prevent the jobs/sets from being split when the stacker 190 goes full. In general, the output of the MFD 140, which can provide pre-collated, for example, page order printed sheets, may be on-line compiled (accumulated in a superposed set) into completed sets of plural sheets. The rendering job as such or the compiled sets may, or may not, be stapled or otherwise bound together. Then each compiled set may be automatically dropped, pushed out, or otherwise stacked on the stacker 190.

The prevent job splitting feature 305 and the prevent set splitting feature 325 can be selected by a user 335 so that the stacker 190 will not begin stacking the job/set unless the stacker 190 possesses a capacity for stacking the complete job/set. The stacker 190 automatically unloads the job/set with respect to a job/set boundary provided by the user 335. The prevent job splitting feature 305 can be selected and a maximum job thickness value 310, in units of millimeters or inches, can be entered. The prevent job splitting feature 305 employs the maximum job thickness value 310 to unload a last whole job that can fit in the stacker 190 before going full utilizing a triggering algorithm 320. The triggering algorithm 320 can determine whether the remaining stacker 190 capacity is less than or equal to the maximum job thickness value 310.

The prevent set splitting feature 325 can be selected and a maximum set thickness value 315, in units of millimeters or inches, can be entered. The prevent set splitting feature 325 employs the maximum set thickness value 315 to unload on the last whole set that can fit in the stacker 190 before going full utilizing a triggering algorithm 330. The triggering algorithm 330 determines whether the remaining stacker 190 capacity is less than or equal to the maximum set thickness value 315.

FIG. 4 illustrates a high level flow chart of operations illustrating logical operational steps of a method 400 for preventing the job/set splitting across the stacker 190, which can be implemented in accordance with an alternative embodiment. Note that the description with respect to FIG. 4 may refer to reference numerals and components from other figures discussed herein. As indicated at block 410, a step or logical operation can be implemented to configure the splitting prevention module 280 to include the prevent job splitting feature 305 and the prevent set splitting feature 325. Then, as depicted at block 420, a step or logical operation can be implemented to select the prevent the job splitting feature 305 or the prevent set splitting feature 325 so that the stacker 190 will not begin stacking the job/set unless the stacker 190 possesses the necessary capacity for stacking the complete job/set.

Next, as shown at block 430, a step or logical operation can be provided in which the maximum job/set thickness value 310 and 315 (e.g., in units of millimeters or inches) can be entered. Thereafter, as depicted at block 440, a step or logical operation can be implemented in which the maximum job/set thickness value 310 and 315 are employed to stack the last whole job that can fit in the stacker 190 before going full, if the remaining stacker 190 capacity is less than or equal to the maximum job/set thickness value 310 and 315. The jobs/sets can be prevented from being split when the stacker 190 goes “full”, as depicted at block 450.

The system 300 ensures that the jobs/sets are not split which prevent manual recompilation. The prevent job splitting feature 305 and the prevent set splitting feature 325 can be extended to other product lines that can physically detect the remaining stacker 190 capacity. The specification of maximum set/job size in dimensional units can be provided by the user 335 to avoid splitting of sets/jobs across the stacker 190. Such an approach reduces the opportunity for the user 335 error when recombining jobs/sets that have been split at non-set boundaries.

Based on the foregoing, it can be appreciated that a number of embodiments are disclosed herein. For example, in one embodiment, a method can be implemented for preventing job/set splitting across a stacker. Such a method can include the steps or logical operations of, for example, configuring a splitting prevention module to include a prevent job splitting feature and a prevent set splitting feature; selecting the prevent job splitting feature or the prevent set splitting feature so that the stacker will not begin stacking a job/set unless the stacker possesses a capacity for stacking the complete job/set; and automatically unloading the job/set with respect to a job/set boundary to prevent the job/set from being split when the stacker becomes full.

In another embodiment, the step or logical operation of selecting the prevent job splitting feature can include the steps or logical operations of entering a maximum job thickness value upon selecting the prevent job splitting feature; and unloading a last complete job that can fit in the stacker before going full if a remaining stacker capacity is less than or equal to the maximum job thickness value. In another embodiment, the step or logical operation of selecting the prevent set splitting feature can include the steps or logical operations of entering a maximum set thickness value upon selecting the prevent set splitting feature; and unloading a last complete set that can fit in the stacker before going full if a remaining stacker capacity is less than or equal to the maximum set thickness value.

In yet another embodiment, the maximum job thickness or the maximum set thickness can be entered in units of millimeters or inches (but it can be appreciated other units of measurements can also be used). In yet another embodiment, a step or logical operation can be provided for detecting the remaining capacity of the stacker by the splitting prevention module. In still another embodiment, a step or logical operation can be implemented for designating the maximum set/job size in dimensional units to avoid splitting of sets/jobs across the stacker. In another embodiment, a step or logical operation can be provided for reducing the opportunity for the user error when recombining the job/set that have been split at a non-set boundary.

In another embodiment, a system can be implemented for preventing job/set splitting across a stacker. Such a system can include, for example, a processor; a data bus coupled to the processor; and a computer-usable medium embodying computer program code, the computer-usable medium being coupled to the data bus, the computer program code comprising instructions executable by the processor and configured for: configuring a splitting prevention module to include a prevent job splitting feature and a prevent set splitting feature; selecting the prevent job splitting feature or the prevent set splitting feature so that the stacker will not begin stacking a job/set unless the stacker possesses a capacity for stacking the complete job/set; and automatically unloading the job/set with respect to a job/set boundary to prevent the job/set from being split when the stacker becomes full.

In another embodiment, the aforementioned instructions for selecting the prevent job splitting feature can comprise instructions configured for: entering a maximum set thickness value upon selecting the prevent job splitting feature; and unloading a last complete job that can fit in the stacker before going full if a remaining stacker capacity is less than or equal to the maximum job thickness value. In still another embodiment, the aformentioned instructions for selecting the prevent set splitting feature can further include instructions configured for entering the prevent set splitting value upon selecting the prevent set splitting feature; and unloading a last complete set that can fit in the stacker before going full if a remaining stacker capacity is less than or equal to the maximum set thickness value.

In another embodiment, the maximum job thickness or the maximum set thickness can be entered in units of millimeters or inches or other units of measurement. In yet another embodiment, the remaining capacity of the stacker is capable of being detected by the splitting prevention module. In yet another embodiment, the aforementioned instructions can be further configured for designating the maximum set/job size in a dimensional unit to avoid splitting of sets/jobs across the stacker. In still another embodiment, a step or logical operation can be provided for reducing the opportunity for the user error when recombining the job/set that have been split at a non-set boundary.

In another embodiment, a processor-readable medium storing computer code representing instructions to cause a process for preventing job/set splitting across a stacker can be implemented. Such computer code can include, for example, code to: configure a splitting prevention module to include a prevent job splitting feature and a prevent set splitting feature; select the prevent job splitting feature or the prevent set splitting feature so that the stacker will not begin stacking a job/set unless the stacker possesses a capacity for stacking the complete job/set; and automatically unload the job/set with respect to a job/set boundary to prevent the job/set from being split when the stacker becomes full.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for preventing job/set splitting across a stacker, said method comprising:
configuring a splitting prevention module in association with a server to include a prevent job splitting feature and a prevent set splitting feature;
selecting via said server said prevent job splitting feature or said prevent set splitting feature so that said stacker will not begin stacking a job/set unless said stacker possesses a capacity for stacking said complete job/set; and
automatically unloading said job/set with respect to a job/set boundary to prevent said job/set from being split when said stacker becomes full.

2. The method of claim 1 wherein selecting said prevent job splitting feature, further comprises:
entering a maximum job thickness value upon selecting said prevent job splitting feature; and
unloading a last complete job that can fit in said stacker before going full if a remaining stacker capacity is less than or equal to said maximum job thickness value.

3. The method of claim 2 wherein selecting said prevent set splitting feature, further comprises:
entering a maximum set thickness value upon selecting said prevent set splitting feature; and
unloading a last complete set that can fit in said stacker before going full if a remaining stacker capacity is less than or equal to said maximum set thickness value.

4. The method of claim 2 wherein said maximum job thickness or said maximum set thickness is entered in units of millimeters or inches.

5. The method of claim 3 further comprising detecting a remaining capacity of said stacker by said splitting prevention module.

6. The method of claim 5 further comprising designating said maximum set/job size in dimensional units to avoid splitting of sets/jobs across said stacker.

7. The method of claim 5 further comprising reducing an opportunity for a user error when recombining said job/set that have been split at a non-set boundary.

8. A system for preventing job/set splitting across a stacker, said system comprising:
a processor;
a data bus coupled to said processor; and
a computer-usable medium embodying computer program code, said computer-usable medium being coupled to said data bus, said computer program code comprising instructions executable by said processor and configured for:
configuring a splitting prevention module in association with a server to include a prevent job splitting feature and a prevent set splitting feature;
selecting via said server said prevent job splitting feature or said prevent set splitting feature so that said stacker will not begin stacking a job/set unless said stacker possesses a capacity for stacking said complete job/set; and
automatically unloading said job/set with respect to a job/set boundary to prevent said job/set from being split when said stacker becomes full.

9. The system of claim 8 wherein said instructions for selecting said prevent job splitting feature, further comprise instructions configured for:
entering a maximum set thickness value upon selecting said prevent job splitting feature; and
unloading a last complete job that can fit in said stacker before going full if a remaining stacker capacity is less than or equal to said maximum job thickness value.

10. The system of claim 9 wherein said instructions for selecting said prevent set splitting feature, further comprise instructions configured for:
entering a said prevent set splitting value upon selecting said prevent set splitting feature; and
unloading a last complete set that can fit in said stacker before going full if a remaining stacker capacity is less than or equal to said maximum set thickness value.

11. The system of claim 10 wherein said maximum job thickness or said maximum set thickness is entered in units of millimeters or inches.

12. The system of claim 10 wherein a remaining capacity of said stacker is capable of being physically detected by said splitting prevention module.

13. The system of claim 12 wherein said instructions are further configured for designating said maximum set/job size in a dimensional unit to avoid splitting of sets/jobs across said stacker.

14. The system of claim 10 wherein said instructions are further configured for reducing an opportunity for a user error when recombining said job/set that have been split at a non-set boundary.

15. A non-transitory computer-readable medium storing computer code representing instructions to cause a process for preventing job/set splitting across a stacker, said computer code comprising code to:
configure a splitting prevention module in association with a server to include a prevent job splitting feature and a prevent set splitting feature;
select via said server said prevent job splitting feature or said prevent set splitting feature so that said stacker will not begin stacking a job/set unless said stacker possesses a capacity for stacking said complete job/set; and
automatically unload said job/set with respect to a job/set boundary to prevent said job/set from being split when said stacker becomes full.

16. The non-transitory computer-readable medium of claim 15 wherein said code further includes code to:
enter a maximum job thickness value upon selecting said prevent job splitting feature; and
unload a last complete job that can fit in said stacker before going full if a remaining stacker capacity is less than or equal to said maximum job thickness value.

17. The processor-readable medium of claim 16 wherein said code further includes code to:
enter a said prevent set splitting value upon selecting said prevent set splitting feature; and
unload a last complete set that can fit in said stacker before going full if a remaining stacker capacity is less than or equal to said maximum set thickness value.

18. The non-transitory computer-readable medium of claim 15 wherein said maximum job thickness or said maximum set thickness is capable of being entered in units of millimeters or inches.

19. The non-transitory computer-readable of claim 15 wherein a remaining capacity of said stacker is capable of being detected by said splitting prevention module.

20. The non-transitory computer-readable of claim 15 wherein said code further includes code to designate said maximum set/job size in dimensional units to avoid splitting of sets/jobs across said stacker.
